(19) United States
(12) Patent Application Publication
(10) Pub. No.: US 2014/0257770 A1
(43) Pub. Date: Sep. 11, 2014

(54) NUMERICAL SIMULATION METHOD FOR THE FLIGHT-ICING OF HELICOPTER ROTARY-WINGS

(71) Applicant: Ming Lu, Tianjin (CN)

(72) Inventor: Ming Lu, Tianjin (CN)

(21) Appl. No.: 13/978,707

(22) PCT Filed: Nov. 30, 2011
(86) PCT No.: PCT/CN2011/083189

§ 371 Date: Jul. 8, 2013

(51) Int. Cl. G06F 17/50

(52) U.S. Cl. CPC G06F 17/5009
USPC 703/2

(57) ABSTRACT

The present invention is related to a numerical simulation method for the flight-icing of helicopter rotary-wings. This invention includes the algorithm of adding the voracity compensation force term to the momentum and energy equations describing the air-supercooled water droplets two-phase rotational flows in the single fluid two-phase flow system in wake domain of helicopter-rotary wings; the algorithm of adding the centrifugal and Coriolis force to the slip velocity equation; the models describing the water film and icing progress containing the effect of the centrifugal and Coriolis force; and the procedure using the above algorithms and models to do simulation.

### TECHNICAL FIELD OF THE INVENTION

The present invention is related to the application of computational fluid dynamics on the aerospace engineering. Particularly, it is a numerical method for simulating the flight-icing of helicopter rotary-wings. This method can be embodied using the computer codes and the code can be run on computers to simulate the flight-icing of helicopter rotary-wings.

### BACKGROUND OF THE INVENTION

Helicopter had widely been used in civil and military domains owing to its flexibility. Generally, the flight attitude of helicopter is below 6000 meter, within which the supercooled water droplets (SWD) in the atmosphere, which exist in form of water droplets at a temperature below the dew point, will impinge on aircraft surfaces, such as wing, body, cockpit, tail, engine nacelle, etc., which results in water film (WF) on aircraft surfaces. If the liquid water contain (LWC, the mass of the SWD per unit volume, with dimension kg/m³) is too high, the accreted water film will become ice on aircraft surfaces. This phenomenon is called the flight-icing. For all type aircrafts, the flight-icing has a performance degradation and severely to a damage.

The rotary-wings of helicopter have multi-function such as lift wing, elevator, rudder, propulsion unit. The flight-icing on the rotary-wings will thread the aircraft flight safety. First, the ice increases the wing loads and output torques of helicopter, and makes aircraft configuration changing, which could deteriorates the stall characteristics. The shedding of the ice on the rotary-wings makes the wing loads uneven, which induces more serious vibration and noise. All above problems make the anti-and de-icing to the rotary-wings be the core and the most complicated task for the helicopter safety flight. Compared to the fixed-wing aircrafts, the rotary-wing aircrafts behave more complicated aerodynamic characteristics, such as the interference between the two adjacent wings, the centrifugal forces produced by wing rotation, etc.

In order to ensure flight safety in icing conditions and meet the FAA or other aircraft certification regulations, which require an aircraft to be able to operate safely throughout the icing envelop, most modern aircrafts install the electro-heating based anti- and de-icing system, which is started according to the feedback from the sensors on some critical locations of on aircraft surface, taking charge in anti- and de-icing action during aircraft flying under the condition of IFR (Instrument Flight Rules).

Generally, the icing anti/de-icing analysis and icing certifications are performed by a combination of the natural flight test, icing wind tunnel test and numerical simulation because each exhibits some deficiencies. The natural flight test has seasonal limitations and is risky in some extreme situations. It cannot test full range of the icing envelope required by FAR Part 25. The icing wind tunnel experimental testing is usually done at low Reynolds number (Re) and cannot simply extrapolate the result to high Re for larger aircraft. Moreover, the generation of the size distribution of SWD like in the atmosphere in the icing wind tunnel is not possible.

Since the 80s last century, the numerical simulation to the flighticing had been studied extensively in the world not only in theory but also in engineering applications. It had become a supporting tool for analysis and certification. The advanced numerical simulation technology can correct the errors and deficiencies in the wind tunnel testing. After 20 year long developing, the numerical simulation to the flighticing has realizes the software products with industrial applicable level, such as the software LEWICW from USA, ONERA from France and Fensap from Canada.

The procedure applied in flighticing simulation software is about the call instructions to three main modules, whose function respectively are

Air flow simulation module: solving the fluid flow governing equations for external flow field;

SWD movement simulation module: solving the SWD movement governing equation for the collision of SWD to aircraft surfaces to find the state of liquid water on aircraft surfaces;

Icing accretion module: solving the icing state of the liquid water film on aircraft surfaces to find ice geometry.

Until now, all the numerical methods applied in those commercial softwares are designed for the fixed-wing aircrafts, on which the flow filed and icing progress is different to those on the rotary-wing aircrafts. For example, the wake of helicopter rotary-wings is featured as the air-SWD two-phase, vortex-dominated compressible flows and the aerodynamic interference between two adjacent rotary-wings since the continually and periodically shedding vortex from one rotor impinge to the following downwind rotor. In those kind vortex-dominated flows, there exist the weak contact discontinuity interfaces, across which the density and tangent velocity is discontinuity; while the normal velocity and pressure is continuity. It is more difficult to capture the contact discontinuity interfaces in numerical simulation, since very little amount of numerical diffusion embodied in numerical method could make them smeared to a point damaging the simulation accuracy. In addition, the WF generated from the collision of SWD and aircraft surfaces is influenced by the Coriolis effect, which can make the WF moves spanwise on rotary-wings, and furthermore make the ice geometry is different to that on the fixed-wings. In conclusion, to usage the numerical solutions to analyze and predict the flight-icing of helicopter rotary-wings, it is necessary to develop the special numerical simulation technology for such complicated phenomena.

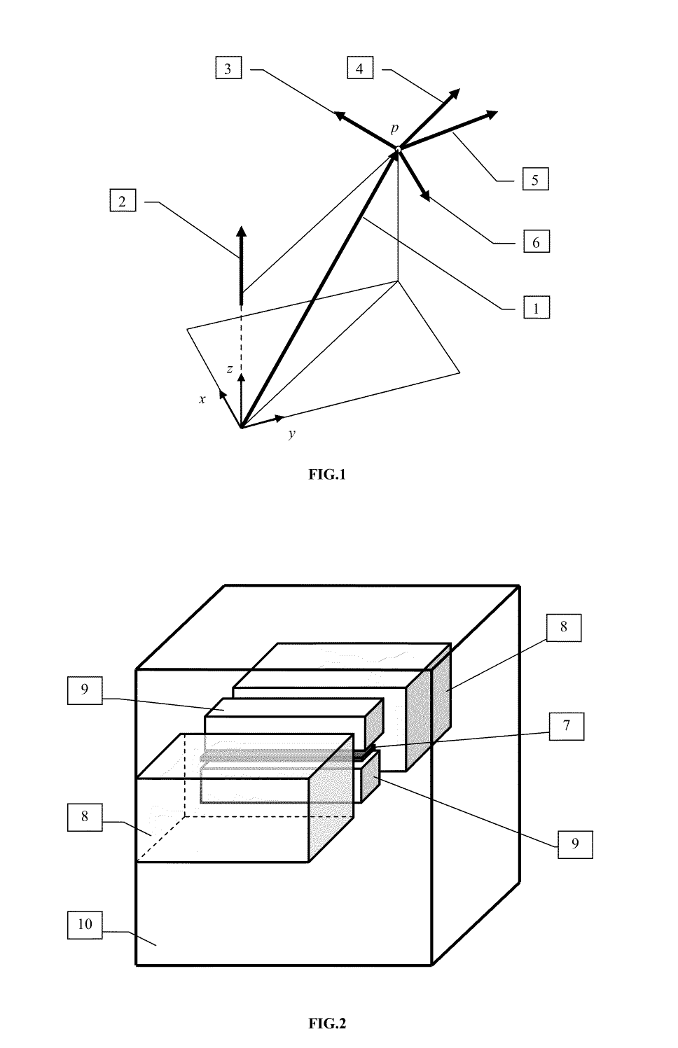

Firstly, for the rotating movement of helicopter rotary-wings, it is convenient to transform the original Cartesian fixed frame of reference into a rotating frame of reference for the computation of the helicopter rotarywing flow field, which is depicted in the FIG. 1, where a point P, located by a vector \vec{r}_{P} (1), rotates with the constant angular velocity of rotary-wing presented as the vector \vec{ω}_{Z0}=[0,0,ω_{Z0}] (2) with the components [0,0,ω_{Z0}], around the Z-coordinate axis. In this situation, it needs to account for the Coriolis force as well as the centrifugal force in the fluid flow governing equations. The unit mass of centrifugal \vec{f}_{centr} (4) and Coriolis \vec{f}_{corio} (6) in the FIG. 1 are defined respectively as

\vec{f}_{centr}=−\vec{ω}_{Z0}×(\vec{ω}_{Z0}×107 \vec{r}_{P}), (1)

\vec{f}_{corio}=−2(\vec{ω}_{Z0}×\vec{V}), (2)

where, \vec{V}=ui+vj+wk with the components u, v, w in i, j, k-direction in Cartesian coordinators, is the velocity vector of the point P in a fixed frame, also the relative velocity (5) in rotating frame of reference; the operator×presents the cross-product operation. In such a frame of reference, any absolute velocity results from the sum of the relative velocity (5) and the entrainment velocity (3), and the fluid flow governing equations can be achieved by adding the two forces per unit mass term to momentum and energy equations.

Besides, the SWD with statistically less than 50 μm are evenly distributed in air, which can be considered as the air-SWD two-phase mixture flows with density (presented by the LWC) around 10³ kg/m³·α₂, the SWD phase volume fraction, is defined as the ratio of LWC to ρ₂, the density of SWD, which is about equal to that of water. On the icing surface of aircraft, LWC becomes large and may be close to density of air in extremity. So that,

$${α}_{2} = \frac{LWC}{{ρ}_{2}} \approx \frac{[ 0.001 ∼ 1 ] kg \text{/} {m}^{3}}{1000 kg \text{/} {m}^{3}} = {10}^{- 6} ∼ {10}^{- 3} , \qquad ( 3 )$$

The material density ratio ξ, is defined as the ratio of ρ₂ to the density of of air ρ₁. So that,

$$ξ = \frac{{ρ}_{2}}{{ρ}_{1}} \approx \frac{1000 kg \text{/} {m}^{3}}{1 kg \text{/} {m}^{3}} = {10}^{3} . \qquad ( 4 )$$

The Stokes number Sk, is defined as the ratio of the relaxation time of SWD t₂ to that of air t₁. Based on experiment data, t₂ is about [10⁵˜10]1/S; while t₁ is about [10³˜10¹]1/S. So that,

$$Sk = \frac{{t}_{2}}{{t}_{1}} \approx \frac{[ {10}^{- 5} ∼ 10 ]}{[ {10}^{- 3} ∼ {10}^{- 1} ]} = {10}^{- 4} ∼ {10}^{4} . \qquad ( 5 )$$

The interaction intensity for air, I₁, is defined as

$${I}_{1} = \frac{ξ}{Sk} {α}_{2} \approx \frac{{10}^{3} [ {10}^{- 6} ∼ {10}^{- 3} ]}{[ {10}^{- 4} ∼ {10}^{4} ]} = {10}^{- 7} ∼ {10}^{4} . \qquad ( 6 )$$

The interaction intensity for SWD, I₂, is defined as

$${I}_{2} = \frac{1}{Sk} = \frac{1}{[ {10}^{- 4} ∼ {10}^{4} ]} = {10}^{- 4} ∼ {10}^{4} . \qquad ( 7 )$$

From the analysis above, in the far-field domain, the effect of the SWD to the air flow can be ignored since α₂ is very small; while in the near-field, it should be included since the interaction between the air and the SWD in the two-phase flow is intensive. Besides, there is a necessary to account for the vortex dynamics in the wake flows of helicopter rotary-wings. From a point of computation efficiency, cost and fidelity, the computational domain in the numerical simulation can be classified into three sub-domains, as shown in the FIG. 2, where around an isolated wing (7), the wake (8), near-field (9) and far-field domain (10) are formed. The different fluid flow governing equations and physical models will be used to describe the air -SWD movement and the icing progress in those different domains.

### Far-Field Domain

The governing equations for the air and the SWD flows can be built separately. Ones for the air flows include the publicly known continuity, momentum, energy equation and the turbulence model in the rotating frame of reference. Their solutions give the information such as the air velocity, density, pressure, temperature, dynamic viscosity and turbulence characteristics, etc. Ones for the SWD flows is built based on the publicly known principle of the Newton's law about the particle kinemics, which needs to account for the viscous drag of the air, gravity, centrifugal and Coriolis force of the SWD.

### Near-Field Domain

The flows closely around aircraft are the air-SWD two-component mixtures, which are homogeneous within a small fluid particle and can be considered as continuum, which is equivalent to a single component fluid. The governing equations of this fluid can be built based on the assumption of single-fluid two-phase system, where the physical properties, such as density, specific heat, viscosity, heat conduction, etc. can be obtained from the weight-averaged volume fraction of different phases. The velocity of the mixture can be obtained from the mass-weighted average. The interaction between the two phases can be recognized by adding a slip velocity of the SWD, which is the differential of the air velocity to the SWD velocity.

The governing equations for the air-SWD single fluid two-phase flows include the continuity, momentum, energy, SWD slip velocity equation, and turbulence model. All above equations are public known in the fixed frame of reference, but need to be rewritten in the rotating frame of reference as done for the far-filed domain.

The numerical simulation of the air-SWD single fluid two-phase flows supplies the information such as the density, pressure, velocity, temperature, viscosity and turbulence of air and SWD at the computing grid points of flow field around rotary-wings. The information can be used as the boundary conditions for the wake and WF calculations.

### SUMMARY OF THE INVENTION

This invention is related to a numerical method for simulating the flight-icing of helicopter rotary-wings. This method can be embodied using the computer language codes and can be run on computers to simulate the state of the flight-icing of helicopter rotary-wings.

This invention includes

the algorithm of adding the Vorticity Compensation Force (VCF) term to the momentum and energy equations in the single fluid two-phase flow system describing the air-SWD two-phase rotational flows in wake domain of helicopter-rotary wings; the algorithm of adding the centrifugal and Coriolis force term to the slip velocity equation; the models describing the WF movement and icing progress containing the effect of the centrifugal and Coriolis force; and the procedure using the above algorithms and models to do simulation.

The governing equations for the single fluid two-phase flow system includes a set of partial difference equations (PDE) plus a slip velocity equation, which are for capturing the vortex structure in the rotary-wing wake. For the models, it needs to consider the effect of the centrifugal and Coriolis force to the change of mass and energy in the WF and ice to find the iced rotary-wing configuration.

### Wake Domain

For helicopters, the wake domain refers to the space between any two adjacent rotary-wings, where is a domain with vortex-dominated flows. The interaction of the wake flows to the adjacent wings can significantly affect the icing progress. The numerical simulation to the wake flows should meet the difficulty caused by the numerical diffusion as not to clearly capture the vortex structure. In this invention, a diffused vorticity is artificially added in computing cells to compensate the numerical diffusion. Formally, a body force is added in the momentum equation. This force is called the VCF (Vorticity Compensation Force).

The velocity of the air-SWD two-phase mixture, \vec{V}ₘ=uₘi+vₘj+wₘk, including three components, uₘ, vₘ, wₘ, in the direction (i, j, k) in the Cartesian coordinate system. The subscript m indicates the mixture. The vorticity of the air-SWD two-phase flows, \vec{ω}ₘ=ωₘₓi+ω_{my}j+ω_{mz}k, according to the definition of the vorticity, is

$$\begin{matrix}{\vec{ω}}_{m} = ∇ \times {\vec{V}}_{m} \\ = \vert \begin{matrix}i & j & k \\ \frac{\partial }{\partial x} & \frac{\partial }{\partial y} & \frac{\partial }{\partial z} \\ u & v & w\end{matrix} \vert \\ = ( \frac{\partial {w}_{m}}{\partial y} - \frac{\partial {v}_{m}}{\partial z} ) i + ( \frac{\partial {u}_{m}}{\partial z} - \frac{\partial {w}_{m}}{\partial x} ) j + ( \frac{\partial {v}_{m}}{\partial x} - \frac{\partial {u}_{m}}{\partial y} ) k .\end{matrix} \qquad ( 8 )$$

The VCF is obtained from the density of mixture ρₘ multiplying with \vec{f}_{ω}, the unite VCF, which has the dimension of force and is defined as

\vec{f}_{ω}=\vec{n}_{ω}×(v_{ω}(∇²\vec{ω}ₘ)R_{c}), (9)

where, the operator x presents the cross-product; vₘ, with the same dimension as the dynamic viscosity, presents the vortex dynamic compensation coefficient; R_{c} presents the characteristic radii of compensated vorticity. In the definition (9), \vec{n}_{ω} presents the gradient direction of the vorticity,

$${\vec{n}}_{ω} = \frac{∇ φ}{\vert ∇ φ \vert} , \qquad ( 10 )$$

where, φ is the magnitude of the vorticity; ∇φ is the gradient of the magnitude of vorticity; |∇φ| is the magnitude of ∇φ. They are defined as

$$\begin{matrix}φ = \vert {\vec{ω}}_{m} \vert = \sqrt{{ω}_{mx}^{2} + {ω}_{my}^{2} + {ω}_{mz}^{2}} , & ( 11 ) \\ ∇ φ = \frac{\partial φ}{\partial x} i + \frac{\partial φ}{\partial x} j + \frac{\partial φ}{\partial x} k , & ( 12 ) \\ \vert ∇ φ \vert = \sqrt{{( \frac{\partial φ}{\partial x} )}^{2} + {( \frac{\partial φ}{\partial y} )}^{2} + {( \frac{\partial φ}{\partial x} )}^{2}} . & ( 13 )\end{matrix}$$

The term |∇φ| tells the maximum change of the vorticity. The vorticity compensation is obtained from the cross-product of the direction of |∇φ| and the vorticity diffusion. The vorticity dynamics coefficient, v_{ω}, in the definition (9) is defined as

$${v}_{ω} = \frac{{R}_{c}^{2}}{\vert {\vec{ω}}_{m} \vert} , \qquad ( 14 )$$

where R_{c}, the radii of the compensated vorticity for two-and three-dimension is defined as

R_{c}=1/2Ω^{1/2} and R_{c}=1/2Ω^{1/3}, (15)

where Ω is any one cell area of computing grid for two-dimensional case; while it is the volume for three-dimensional case.

In the wake domain, the assumptions for simulation of the air-SWD two-phase flows are

1. Neglecting the gravity of air;

2. Considering the turbulence of air;

3. Considering the effect of the SWD to the air;

4. Considering the drag of the air to the SWD;

5. Considering the gravity, centrifugal, Coriolis force and the VCF in the air-SWD mixture;

6. Not considering the turbulence of the SWD;

7. Not considering the collision, coalescence, and breakup of the SWD;

8. Not considering the phase changes of the air and the SWD.

Based on the above assumptions, in the wake domain, the single fluid two-phase mixture flow model for the numerical simulation of the flight-icing of helicopter rotary-wings includes five PDE, where the continuity (fraction diffusion) equation is publicly known, the momentum and energy equations need to be added the VCF term, and the SWD slip velocity equation needs to be added the centrifugal and Coriolis force term, according to this invention. In detailed, they are

The momentum equation

$$\frac{\partial {ρ}_{m} {\vec{V}}_{m}}{\partial t} + ∇ \cdot ( {ρ}_{m} {\vec{V}}_{m} {\vec{V}}_{m} ) = - ∇ {p}_{m} - ∇ \cdot ( {ρ}_{m} {c}_{2} ( 1 - {c}_{2} ) {\vec{V}}_{S} {\vec{V}}_{S} ) + {ρ}_{m} ( \vec{g} + {\vec{f}}_{centr} + {\vec{f}}_{corio} + {\vec{f}}_{ω} ) ; \qquad ( 16 )$$

The energy equation

$$\frac{\partial {ρ}_{m} {E}_{rm}}{\partial t} + ∇ \cdot ( {ρ}_{m} {H}_{rm} {\vec{V}}_{m} ) = - ∇ \cdot ( {ρ}_{m} {c}_{2} ( 1 - {c}_{2} ) {\vec{V}}_{S} {\vec{V}}_{S} ) {\vec{V}}_{m} + {ρ}_{m} ( \vec{g} + {\vec{f}}_{centr} + {\vec{f}}_{corio} + {\vec{f}}_{ω} ) {\vec{V}}_{m} ; \qquad ( 17 )$$

The SWD slip velocity equation

$${\vec{V}}_{S} = \frac{{f}_{d} {ρ}_{2} {d}^{2}}{18 μ} ( \frac{{ρ}_{2} - {ρ}_{m}}{{ρ}_{1}} ) [ \vec{g} + {\vec{f}}_{centr} + {\vec{f}}_{corio} - ( {\vec{V}}_{m} \cdot ∇ ) {\vec{V}}_{m} - \frac{\partial {\vec{V}}_{m}}{\partial t} ] . \qquad ( 18 )$$

In the equation (16-17), the VCF term, ρₘ\vec{f}_{ω}, is treated as a source term and any variables with subscript m present the mixture, 1 for the air, and 2 for the SWD. The density, velocity vector, pressure, temperatures, and time are presented respectively by ρ, \vec{V}, p, T, t. The velocity vector has the components u, v, w in the direction x, y, z of the Cartesian coordinator. The material property parameters, such as the viscosity, specific heat, conduction are presented respectively by μ,Cᵥ,Cp,λ. The gravity vector \vec{g}, \vec{g}=gₓi+g_{y}j+g₂k; for the rotating frame of reference, the energy equation needs to use the roergy , Eᵣ, and the rothalpy, Hᵣ,

$$\begin{matrix}{E}_{rm} = {C}_{vm} {T}_{m} + \frac{{u}_{m}^{2} + {v}_{m}^{2} + {w}_{m}^{2}}{2} - \frac{{ω}_{OZ}^{2} ( {x}^{2} + {y}^{2} )}{2} , & ( 19 ) \\ {H}_{rm} = {C}_{pm} {T}_{m} + \frac{{u}_{m}^{2} + {v}_{m}^{2} + {w}_{m}^{2}}{2} - \frac{{ω}_{OZ}^{2} ( {x}^{2} + {y}^{2} )}{2} . & ( 20 )\end{matrix}$$

In the air-SWD mixture, the volume fraction of air is α₁ and that of SDW is α₂. For the mixture, the density is ρₘ and the material property parameters, such as the viscosity of mixture μₘ, are obtained from the volume average, which means

ρₘ=α₁ρ₁+α₂ρ₂ (21)

μₘ=α₁μ₁+α₂μ₂; (22)

while \vec{V}ₘ, the velocity of mixture, is obtained from the mass average, which means

$${\vec{V}}_{m} = \frac{1}{{ρ}_{m}} ( {α}_{1} {ρ}_{1} {\vec{V}}_{1} + {α}_{2} {ρ}_{2} {\vec{V}}_{2} ) ; \qquad ( 23 )$$

and c₂ is defined as the mass fraction of SWD

$${c}_{2} = \frac{{α}_{2} {ρ}_{2}}{{ρ}_{m}} . \qquad ( 24 )$$

In the equation (18), \vec{V}, presents the SDW slip velocity; d is the diameter of SWD and f_{d} is the drag coefficient,

$${f}_{d} = \{ \begin{matrix}1 + 0.15 {Re}^{0.687} , & Re \geq 1000 \\ 0.0183 Re , & Re < 1000 ,\end{matrix} \qquad ( 25 )$$

where the Reynolds number of the SWD is

$$Re = \frac{{ρ}_{2} {\vert \vec{V} \vert}_{2} d}{{μ}_{2}} . \qquad ( 26 )$$

The unit centrifugal force \vec{f}_{centr} and Coriolis force \vec{f}_{corio} has been given in the definition (1-2). If considering the turbulence effect, the equations above need to be treated by Favre-average.

The simulation in the wake domain gives the velocity, density, pressure, temperature, viscosity and turbulence, etc. of the air-SWD two-phase flows.

### Water Film (WF) Movement

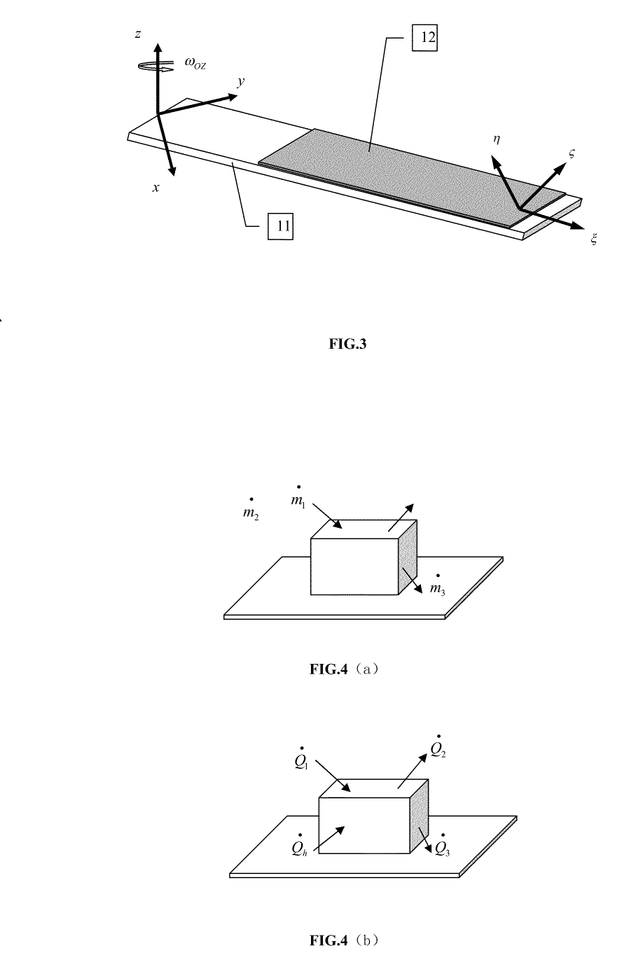

The WF forms when the SWD impinge on aircraft surface. The flight-icing phenomenon firstly occurs on the interface of the WF and the non-iced (clean) aircraft surface. The ice layer firstly appears there and then does outwards. The FIG. 3 shows the local coordinator system (o, ξ, ζ, η) for the WF built on a rotary-wing. In the local coordinator system, η—is the normal direction of solid wall, and also the normal direction of WF movement; -is the direction of wing spanwise; ζ—is the direction of chordwise. The boundaries of the WF movement involve the interfaces of the WF and the air-SWD mixture flows, the WF and the solid wall, the WF and the ice layer.

The WF velocity \vec{V}_{f}=u_{ξ}i+v_{ζ}j+w_{η}k, where u_{ξ}, v_{ζ}, w_{η} are the components of \vec{V}_{f} along the direction (ξ, ζ, η) and i,j,k is the index of the coordinator (ξ, ζ,η) system. The simulation to the WF movement needs the following assumptions

1. The WF flow is incompressible flows;

2. Only exists the effect of the air-SWD mixture to the WF;

3. There is no effect of impingement of the SWD to the WF movement.

Since the WF is very thin, its movement along the wall normal direction is a small quantity, which means that w_{η}<<u_{ξ}, v_{ζ}. At the same time, the change rate of variables along its movement is small quantity also, which means that ∂/∂_{η}>>∂/∂ξ, ∂/∂_{ζ}. So that, it is reasonable to assume the term w_{η}=0 and cancel the terms ∂/∂ξ, ∂/∂ζ. To further simplify the WF movement, it is necessary to do the dimensional analysis to all the forces in the movement. There is a common situation:

the rotary-wing speed ω=1200 rpm ; the WF velocity V_{f}=1 m/s; the WF thickness δ=10⁻⁴ m; the water film density ρ_{w}=10³ Kg/m³; the characteristic length of WF (chord length) l=0.1 m; the wing spanwise length B=2 m; the WF kinematic viscosity v_{w}=10⁻⁶ m²/s; the WF surface tension coefficient σ=1N/m. If the viscosity force is used as the reference to other forces, then one has the inertial force/the viscosity force;

$$\frac{{ρ}_{w} {V}_{f} \frac{\partial {V}_{f}}{\partial ξ}}{{μ}_{w} \frac{{\partial }^{2} {V}_{f}}{\partial {η}^{2}}} \approx \frac{{V}_{f} {δ}^{2}}{{v}_{w} l} = {10}^{- 3} ;$$

the pressure/the viscosity force:

$$\frac{\frac{\partial p}{\partial ξ}}{{μ}_{w} \frac{{\partial }^{2} {V}_{f}}{\partial {η}^{2}}} \approx \frac{- {ρ}_{w} {V}_{f} \frac{\partial {V}_{f}}{\partial ξ}}{{μ}_{w} \frac{{\partial }^{2} {V}_{f}}{\partial {η}^{2}}} \approx \frac{{V}_{f} {δ}^{2}}{{v}_{w} l} = - {10}^{- 3} ;$$

the surface tension/the viscosity force:

$$\frac{σ \frac{{\partial }^{3} η}{\partial {ξ}^{3}}}{{μ}_{w} \frac{{\partial }^{2} {V}_{f}}{\partial {η}^{2}}} \approx \frac{σ}{{μ}_{w} {V}_{f}} {( \frac{δ}{l} )}^{3} = {10}^{- 6} ;$$

the gravity/the viscosity force:

$$\frac{{ρ}_{w} g}{{μ}_{w} \frac{{\partial }^{2} {V}_{f}}{\partial {η}^{2}}} \approx \frac{g {δ}^{2}}{{v}_{w} {V}_{f}} = {10}^{- 1} ;$$

the centrifugal/the viscosity force:

$$\frac{{ρ}_{w} ω {B}^{2}}{{μ}_{w} \frac{{\partial }^{2} {V}_{f}}{\partial {η}^{2}}} \approx \frac{ω {B}^{2} {δ}^{2}}{{v}_{w} {V}_{f}} = 4 \times {10}^{- 1} ;$$

the Coriolis/the viscosity force:

$$\frac{2 {ρ}_{w} ω {V}_{f}}{{μ}_{w} \frac{{\partial }^{2} {V}_{f}}{\partial {η}^{2}}} \approx \frac{2 ω {δ}^{2}}{{v}_{w}} = 4 \times {10}^{- 1} .$$

Consider the order of the force ratios above and neglect any one smaller than 10⁻³, one can derive a new assumption: account for the gravity, centrifugal and Coriolis force; neglect the pressure and inertial force in the WF; neglect the surface tension on the WF surface.

Based on all assumptions above, the momentum equation of the WF movement is obtained as

$$\frac{\partial }{\partial η} ( {μ}_{w} \frac{\partial {\vec{V}}_{f} ( ξ , ς , η )}{\partial η} ) + {ρ}_{w} {\vec{f}}_{f} ( {\vec{V}}_{f} , ξ , ς , η ) = 0 , \qquad ( 27 )$$

where \vec{V}_{f}(ξ,ζ,η) is the WF velocity; μ_{w} and ρ_{w} is the dynamic viscosity and the density of WF respectively, which are functions of the temperature T_{w}. \vec{f}_{f} is the summation of the projected unit gravity, centrifugal and Coriolis force, which means

\vec{f}_{f}=\vec{f}_{gcf}+\vec{f}_{cof}, (28)

where the summation of the unit gravity \vec{g} and centrifugal \vec{f}centr is projected on the local coordinator system as \vec{f}_{gcf}, which means

\vec{f}_{gcf} e̅•(\vec{g}+\vec{f}_{centr}), (29)

where e̅ represents a transformation tensor between the original coordinator system (o, x, y, z) and the local one (o,ξ,ζ,η). In detailed,

$$\overline{\overline{e}} = [ \begin{matrix}cos θ & sin θ & 0 \\ - cos α sin θ & cos α cos θ & sin α \\ sin α sin θ & - sin α cos θ & cos α\end{matrix} ] , \qquad ( 30 )$$

where θ and α are defined in the FIG. 3. Following the same principle, the angular velocity \vec{ω}_{OZ} of rotary-wing in (o, x, y, z) can be projected on (o,ξ,ζ,η) system, which means

\vec{ω}_{OZ,f}= e̅•\vec{ω}_{OZ}. (31)

Referring the definition (2), the unit mass of Coriolis \vec{f}_{cof} in (o,ξ,ζ,η) system is

\vec{f}_{cof}=−2\vec{ω}_{OZ,f}×\vec{V}_{f}. (32)

Bring the equations (28-32) into (27) and integrate the WF thickness h_{f} within domain └η,h_{f}┘, with considering the definition of the WF shear stress \vec{τ}_{w}=μ_{w}∂\vec{V}_{f}/∂n and the assumption about the WF surface tension, which is equivalent to \vec{τ}=μₘ∂\vec{V}ₘ/∂η=\vec{τ}_{w}, where \vec{τ}ₘ and μₘ is respectively the shear stress vector along (ξ, ζ) direction on the interface (η=h_{f}) of the air-SWD mixture and the mixture dynamic viscosity. One can obtain the WF velocity \vec{V}_{f} on the plane (ξ. ζ) with height η. It is

$${\vec{V}}_{f} ( ξ , ς , η ) = \overline{\overline{K}} • η [ \frac{{\vec{τ}}_{m}}{{μ}_{m}} - \frac{{ρ}_{w} ( {h}_{f} - η )}{{μ}_{w}} {\vec{f}}_{gcf} ] , \qquad ( 33 )$$

where K̅ is the Coriolis coefficient tensor, which presents the effect of Coriolis force. In detailed and formally, it is

$$\overline{\overline{K}} = [ \begin{matrix}1 & - {k}_{3} & {k}_{2} \\ {k}_{3} & 1 & - {k}_{1} \\ - {k}_{2} & {k}_{1} & 1\end{matrix} ] , \qquad ( 34 )$$

where the element [k₁, k₂, k₃] is the three components of vector \vec{k} in direction (ξ, ζ, η) and the vector \vec{k} is defined as

$$\vec{k} = {[ {k}_{1} , {k}_{2} , {k}_{3} ]}^{T} = \frac{- 2 {ρ}_{w} η ( {h}_{f} - η )}{{μ}_{w}} {\vec{ω}}_{OZ , f} . \qquad ( 35 )$$

Now, the averaged WF velocity is defined as

$${{V}^{{\_}^{->}}}_{f} ( ξ , ϛ , η ) = \frac{1}{{h}_{f}} {\int }_{0}^{{h}_{f}} {{V}^{->}}_{f} ( ξ , ϛ , η ) d η . \qquad ( 36 )$$

The velocity or averaged velocity of the WF is the solution of the WF momentum equation. All the assumptions used in this part are not suitable for the following icing accretion model.

### Icing Process Model

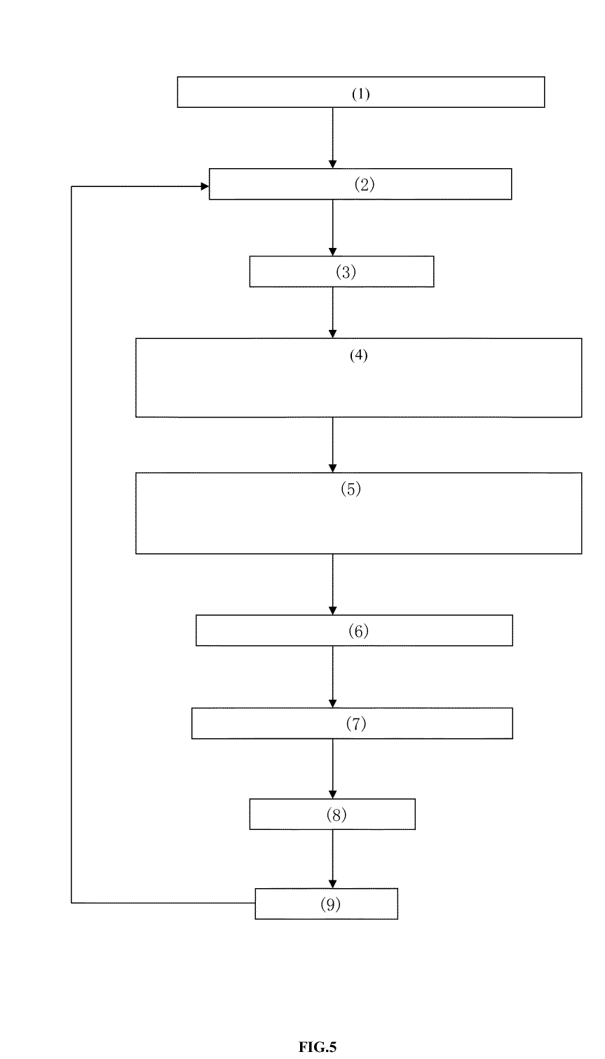

For the icing process, the collection of the SWD, the vaporization of the WF and the generation of ice can make the mass transfer across the boundaries of the WF movement. Besides, the Coriolis force also makes the mass transfer within the WF. During a time period, the WF mass system comes balanced as long as the temperature distribution within the ice layer and the WF continually changes. The FIG. 4(a) shows during the icing progress the WF mass conservation system used in this invention. \dot{m}₁ is the mass flux of impinging SWD coming into the WF; \dot{m}₂ is that of evaporation coming out of the WF; \dot{m}₃ is that of accreted ice coming out of the WF. Their dimension are kg/(m²·s). According to the mass conservation law, the continuity equation of the WF icing progress can be written as

$$\frac{\partial {ρ}_{w} {h}_{f}}{\partial t} + ∇ ( {ρ}_{w} {{V}^{{\_}^{->}}}_{f} {h}_{f} ) = {\dot{m}}_{1} - {\dot{m}}_{2} - {\dot{m}}_{3} , \qquad ( 37 )$$

where

$$∇ = \frac{\partial }{\partial ξ} i + \frac{\partial }{\partial ϛ} j + \frac{\partial }{\partial η} k ;$$

\dot{m}₁ is the function of α₂, \vec{V}₂ and T_{w} (the temperature of the WF); \dot{m}₂ is the function of T_{w} also and its expression is public known.

The FIG. 4(b) shows the WF energy conservation system used in this invention during the icing progress. \dot{Q}₁ is the heat flux of impinging SWD; \dot{Q}₂ is that of evaporation/sublimation; \dot{Q}₃ is that of leaving due to ice accretion; \dot{Q}ₕ is that of conduction of the wall. Their dimension is W/m². According to the energy conservation law, the energy equation of the WF icing progress is written as

$$\frac{\partial ( {ρ}_{w} {h}_{f} {C}_{pw} {T}_{w} )}{\partial t} + ∇ ( {ρ}_{w} {{V}^{{\_}^{->}}}_{f} {h}_{f} {C}_{pw} {T}_{w} ) = {\dot{Q}}_{1} - {\dot{Q}}_{2} + {\dot{Q}}_{3} + {\dot{Q}}_{h} , \qquad ( 38 )$$

where \dot{Q}₁ is expressed in the rotating frame of reference as

$${\dot{Q}}_{1} = [ {C}_{pw} {T}_{2 , ∞} + \frac{{‖ {{V}^{->}}_{2} ‖}^{2}}{2} - \frac{{ω}_{OZ}^{2} ( {x}^{2} + {y}^{2} )}{2} ] \cdot L W C \cdot β ; \qquad ( 39 )$$

where C_{pw} is the specific heat at constant pressure of water; T_{2,∞} the temperature of SWD at the infinite; β is the local water collection efficiency. \dot{Q}₂, \dot{Q}₃ and \dot{Q}ₕ all are the functions of T_{w} and their expression are publicly known.

From the equation (37-39), one can obtain h_{f}, T_{w} and \dot{m}₃. \dot{m}₃ can be changed into the ice thickness, which presents a new ice layer formed. Until now, the numerical simulation for the flight-icing of helicopter rotary-wings during one time interval is finished.

After that, a new computing grid needs to be regenerated according to the iced configuration of aircraft, and then the computation for the next time interval follows. The FIG. 5 presents the procedure in this invention for the numerical simulation for the flight-icing of helicopter rotary-wings. In detailed,
(1) build the rotating frame of reference and generate the computing grid around the un-iced rotary-wings;
(2) divide the whole computational domain into three sub-domains: the far-filed, near-filed and wake domain;
(3) specify the initial time t;
(4) solve the governing equations for the air and SWD flows at the far-field domain to obtain the velocity, density, pressure, temperature, turbulence of air flow and the velocity of SDW;
(5) solve the governing equations for the air-SWD single fluid two-phase mixture flows at the near-field and wake domain to obtain the pressure pₘ, velocity \vec{V}ₘ, temperature Tₘ, dynamic viscosity μₘ, and shear stress τₘ;
(6) solve the WF movement equation to obtain \vec{V}_{f}, the velocity of the WF and find the WF thickness h_{f} ;
(7) solve the icing progress model to find the ice thickness and obtain the iced configuration of rotary-wings;
(8) regenerate the computing grid;
(9) go back to step (2) for the computation at the next time (t+Δt).

The originality of the method presented in this invention lies in:

separately build and solve the governing equations for the air and the SWD at the far-field without accounting for the effect of the SWD to the air; while solve the governing equations for the air-SWD single fluid two-phase mixture flows and solve the SWD slip velocity model at the near-field and wake domain with accounting for the interaction between the two phases. In the WF movement and ice process models, the effect from rotation movement is added. All above make possible precisely capture the vortex structure and calculate the ice shape. This method is reliable, efficient, and practical.

### BRIEF DESCRIPTION OF THE DRAWINGS

The FIG. 1 is the rotating frame of reference for the computation of the flow field of helicopter rotarywings.

The FIG. 2 is the classification of the computational domain in the numerical simulation for the flight-icing of helicopter rotary-wings.

The FIG. 3 is the local coordinator system for the water film built on a rotary-wing on the rotating frame of reference, where (11) is the rotary-wing; (12) is the water film.

The FIG. 4(a) is the mass conservation system in the water film.

The FIG. 4(b) is the energy conservation system in the water film.

The FIG. 5 is the procedure for the numerical simulation for the flight-icing of helicopter rotary-wings.

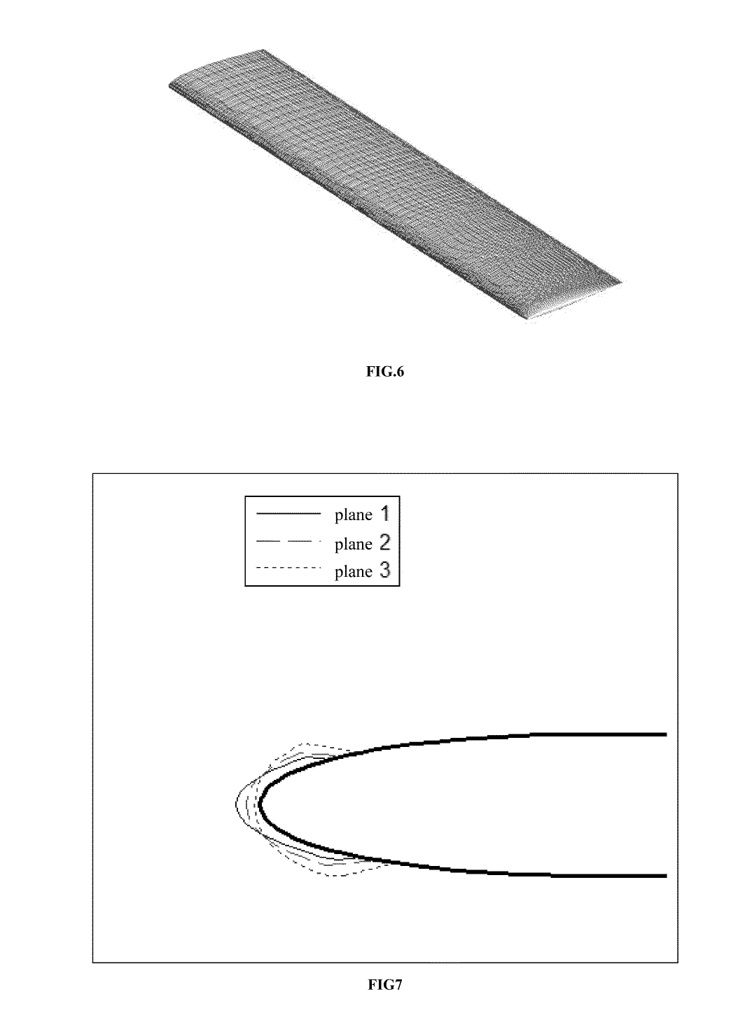

The FIG. 6 is the computing grid on the surface on one three-dimensional wing with NACA0012 section view.

The FIG. 7 is the numerically simulated results of flight-icing.

### DETAILED DESCRIPTION OF THE PREFERRED EMBODIMENT

A preferred embodiment according to the invention is illustrated following. It is related to a numerical simulation method for the flight-icing of helicopter rotary-wings with a section view of NACA0012 airfoil. This method can be embodied using the computer language codes and the codes can be run on computers to do the simulation.

The computational domain only covers one quarter quadrant, where includes one rotary-wing, with spanwise ratio of 7 and two-dimensional section view of NACA0012 airfoil, rotating around Z-axial. The computing grid is a multi-block structured hexahedron grid. On each two-dimensional section view, the grid is the 0-type grid with 192 cells around the airfoil and 48 cells along normal direction of airfoil wall. Totally 32 cells are along the spanwise of the wing. The FIG. 6 shows the computing grid on the surface of one three-dimensional wing with NACA0012 section view. The spatial discretization scheme in the numerical method to solve any governing equation in this embodiment is Finite Volume Method (FVM), for which all computing cells constructed with computing grid are considered as the control volumes and all variables are stored in the center of cells. There are some conditions for the numerical simulation.

The aircraft flying velocity or velocity at infinite: 57 m/s;

The rotating speed of wing or the rotating speed of Z-axial: 1200 rpm;

The atmosphere temperature: 243K;

The atmosphere pressure: 100 kPa;

The angle of attack: 0°;

LWC: 2.58 g/m³;

Medium distribution size of SWD: 50 μm;

The ice density: 917 kg/m³.

Referring to the FIG. 2, where up to 10 times chord length of airfoil is the far-field domain starting boundary; while the wake domain is located upstream and downstream of the wing and it is up to 5 times chord length along Z-axial. The other domain is the near-field domain.

### Far-Field Domain

The assumptions for the numerical simulation in the far-field domain are:

1. there is no effect of the SWD to the air;

2. there is the turbulence in the air movement;

3. there are effects of the air drag, gravity, centrifugal and Coriolis force to the SWD;

4. there is no turbulence in the SWD movement;

5. there is no coalescence, collision, breakup for the SWD;

6. there is no phase changes between the air and the SWD.

The governing equations for the air and the SWD flows can be built separately. Ones for the air flows include the publicly known continuity, momentum, energy equations and the Baldwin-Lomax turbulence model in the rotating frame of reference. The energy equation needs to use the roergy, Eᵣ₁, and the rothalpy, Hᵣ₁, which are already defined in (19-20). Here, they are written as

$$\begin{matrix}{E}_{r 1} = {C}_{v 1} {T}_{1} + \frac{{u}_{1}^{2} + {v}_{1}^{2} + {w}_{1}^{2}}{2} - \frac{{ω}_{OZ}^{2} ( {x}^{2} + {y}^{2} )}{2} , & ( 40 ) \\ {H}_{r 1} = {C}_{p 1} {T}_{1} + \frac{{u}_{1}^{2} + {v}_{1}^{2} + {w}_{1}^{2}}{2} - \frac{{ω}_{OZ}^{2} ( {x}^{2} + {y}^{2} )}{2} . & ( 41 )\end{matrix}$$

Their solutions give the information of the air velocity, density, pressure, temperature, dynamic viscosity, turbulence characteristics and the SWD velocity in the far-field domain.

### Near-Field Domain

A Sub-domain with 5 times chord distance from the wing is near-field, which has a difference of the assumption for the numerical simulation from the far-field: the SWD has the effect to the air.

Within this domain, the governing equations of the air-SWD mixture can be built based on assumption of the air-SWD single fluid two-phase flow systems. To present the interaction between the two phases, a SWD slip velocity equation is added. The SWD slip velocity in the mixture is the difference of the SWD velocity \vec{V}₂to the air velocity \vec{V}₁,

\vec{V}_{S}=\vec{V}₂−\vec{V}₁. (42)

After obtaining \vec{V}_{S}, one can find the SWD relative velocity \vec{V}ₘ₂ by

$${{V}^{->}}_{m 2} = ( 1 - \frac{{ρ}_{2} {α}_{2}}{{ρ}_{m}} ) {{V}^{->}}_{S} , \qquad ( 43 )$$

which is actually the difference of the SWD velocity and the mixture velocity. So that the SWD velocity \vec{V}₂ can be found by

\vec{V}₂=\vec{V}ₘ₂+\vec{V}ₘ. (44)

The numerical simulation of the air-SWD single fluid two-phase flows supplies the information such as the density, pressure, velocity, temperature, viscosity and turbulence of the air and the SWD at the computing grid points of in the near field of flow around aircraft. The information can be used as the boundary conditions for the wake and water film calculations.

### Wake Domain

The wake domain, surrounded by the near-field domain and with the same assumptions as its surrounding, is characterized by the vortex-dominated air-SWD two-phase flows. The conservation form of the governing equations for the flows are

$$\frac{\partial }{\partial t} {\int }_{Ω} {{W}^{->}}_{m} d Ω + {∮}_{\partial Ω} ( {{F}^{->}}_{{c}_{m}} - {{F}^{->}}_{S} - {{F}^{->}}_{v m} ) d S = {\int }_{Ω} {{Q}^{->}}_{m} d Ω , \qquad ( 45 )$$

where the conservation variables \vec{W}ₘ, the convection vector \vec{F}_{cm}, the viscous vector \vec{F}ᵥₘ, the slip velocity(\vec{V}ₛ=uₛi+vₛj+wₛk) induced convection vector \vec{F}_{S} and the source term \vec{Q}ₘ are presented with the unit normal vector (\vec{n}=nₓi+n_{y}j+n_{z}k) respectively as

$${{W}^{->}}_{m} = [ \begin{matrix}{α}_{2} \\ {ρ}_{m} \\ {ρ}_{m} {u}_{m} \\ {ρ}_{m} {v}_{m} \\ {ρ}_{m} {w}_{m} \\ {ρ}_{m} {E}_{r m}\end{matrix} ] , {{F}^{->}}_{{c}_{m}} = [ \begin{matrix}{α}_{2} {V}_{m} \\ {ρ}_{m} {V}_{m} \\ {ρ}_{m} {u}_{m} {V}_{m} + {n}_{x} {p}_{m} \\ {ρ}_{m} {v}_{m} {V}_{m} + {n}_{y} {p}_{m} \\ {ρ}_{m} {w}_{m} {V}_{m} + {n}_{z} {p}_{m} \\ {ρ}_{m} {H}_{r m} {V}_{m}\end{matrix} ] , \\ {{F}^{->}}_{{v}_{m}} = [ \begin{matrix}0 \\ 0 \\ {n}_{x} {τ}_{{xx }_{m}} + {n}_{y} {τ}_{{xy}_{m}} + {n}_{z} {τ}_{{xz}_{m}} \\ {n}_{x} {τ}_{{yx}_{m}} + {n}_{y} {τ}_{{yy}_{m}} + {n}_{z} {τ}_{{yz}_{m}} \\ {n}_{x} {τ}_{{zx}_{m}} + {n}_{y} {τ}_{{zy}_{m}} + {n}_{z} {τ}_{{zz}_{m}} \\ {n}_{x} {Θ}_{{x}_{m}} + {n}_{y} {Θ}_{{y}_{m}} + {n}_{z} {Θ}_{{z}_{m}}\end{matrix} ] , \\ {{F}^{->}}_{S} = [ \begin{matrix}0 \\ 0 \\ {ρ}_{m} {c}_{2} ( 1 - {c}_{2} ) {u}_{s} {V}_{s} \\ {ρ}_{m} {c}_{2} ( 1 - {c}_{2} ) {v}_{s} {V}_{s} \\ {ρ}_{m} {c}_{2} ( 1 - {c}_{2} ) {w}_{s} {V}_{s} \\ 0\end{matrix} ] , \\ {{Q}^{->}}_{m} = [ \begin{matrix}0 \\ 0 \\ {ρ}_{m} {f}_{x} + {ρ}_{m} {ω}_{Z} ( x {ω}_{Z O} - 2 {v}_{m} ) \\ {ρ}_{m} {f}_{y} + {ρ}_{m} {ω}_{Z} ( y {ω}_{ZO} - 2 {u}_{m} ) \\ {ρ}_{m} {f}_{z} \\ {ρ}_{m} {f}^{->} \cdot {{V}^{->}}_{m}\end{matrix} ] , \qquad ( 46 )$$

where the mixture velocity contravariant Vₘ and the slip velocity contravariant Vₛ are defined as

Vₘ=uₘnₛ+vₘn_{y}+wₘn_{z}, (47)

Vₛ=uₛnₓ+vₛn_{y}+wₛn_{z}. (48)

The roergy, Eᵣₘ, and the rothalpy, Hᵣₘ, for the mixture have the same expression as those for the far-field domain in the equation (40-41) with replacing the air velocity w the mixture velocity. In the equation (46), \vec{f} is the body force, which is the sum vector of the mass unit gravity \vec{g} and VCF \vec{f}_{ω}

\vec{f}=\vec{g}+\vec{f}_{ω}. (49)

Besides, in this invention is added a SWD slip velocity in the rotating frame of reference given in equation (18). Particularly, its three-dimensional expression is

$${{V}^{->}}_{S} = {[ {u}_{s} , {v}_{s} , {w}_{s} ]}^{T} = \frac{{f}_{d} {ρ}_{2} {d}^{2}}{18 μ} ( \frac{{ρ}_{2} - {ρ}_{m}}{ρ} ) [ \begin{matrix}{ω}_{m} ( x {ω}_{m} - 2 {v}_{m} ) - \frac{{v}_{ω} {R}_{c}}{\vert ∇ φ \vert} ( \frac{\partial φ}{\partial x} \frac{{\partial }^{2} {ω}_{{m}_{z}}}{\partial {z}^{2}} - \frac{\partial φ}{\partial z} \frac{{\partial }^{2} {ω}_{{m}_{z}}}{\partial {y}^{2}} ) - {u}_{m} \frac{\partial {u}_{m}}{\partial x} - \frac{\partial {u}_{m}}{\partial t} \\ {ω}_{m} ( y {ω}_{m} - 2 {u}_{m} ) - \frac{{v}_{ω} {R}_{c}}{\vert ∇ φ \vert} ( \frac{\partial φ}{\partial x} \frac{{\partial }^{2} {ω}_{{m}_{z}}}{\partial {z}^{2}} - \frac{\partial φ}{\partial z} \frac{{\partial }^{2} {ω}_{{m}_{z}}}{\partial {y}^{2}} ) - {v}_{m} \frac{\partial {v}_{m}}{\partial y} - \frac{\partial {v}_{m}}{\partial t} \\ {g}_{z} - \frac{{v}_{ω} {R}_{c}}{\vert ∇ φ \vert} ( \frac{\partial φ}{\partial x} \frac{{\partial }^{2} {ω}_{{m}_{z}}}{\partial {z}^{2}} - \frac{\partial φ}{\partial z} \frac{{\partial }^{2} {ω}_{{m}_{z}}}{\partial {y}^{2}} ) - {w}_{m} \frac{\partial {w}_{m}}{\partial z} - \frac{\partial {w}_{m}}{\partial t}\end{matrix} ] . \qquad ( 50 )$$

### Water Film (WF) Movement

As discussed before, the rotating axis in the coordinator system the is Z-axial and the wing rotating speed vector is \vec{ω}_{ZO}=[0,0,ω_{ZO}]. In the local (o, ξ, λ, η) coordinator system in the FIG. 3, the equation (29) and the rotating speed vector of Z-axis are respectively expressed as

$$\begin{matrix}{{f}^{->}}_{gcf} = [ \begin{matrix}{ω}_{Z}^{2} ( x cos θ + y sin θ ) \\ {g}_{z} sin α - {ω}_{Z}^{2} ( x cos αsin θ - y cos α cos θ ) \\ {g}_{z} cos α + {ω}_{Z}^{2} ( x sin αsin θ - y sin αcos θ )\end{matrix} ] ; & ( 51 ) \\ {{ω}^{->}}_{OZ , f} = {[ 0 , {ω}_{Z} sin α , {ω}_{Z} cos α ]}^{T} . & ( 52 )\end{matrix}$$

Bring the above two into the equation (35) and cancel the second order small quantity η², one can obtain the three components in the direction (ξ, ζ, η) of vector \vec{k}, which is

$${k}^{->} = {[ {k}_{1} , {k}_{2} , {k}_{3} ]}^{T} = \frac{- 2 {ρ}_{w} {h}_{f} η}{{μ}_{w}} [ \begin{matrix}0 \\ {ω}_{OZ} sin α \\ {ω}_{OZ} cos α\end{matrix} ] . \qquad ( 53 )$$

Further, in the equation (34), the Coriolis coefficient tensor K̅ becomes

$${K}^{\overline{\_}} = [ \begin{matrix}1 & \frac{2 {ρ}_{w} {h}_{f} η}{{μ}_{w}} {ω}_{Z} cos α & \frac{- 2 {ρ}_{w} {h}_{f} η}{{μ}_{w}} {ω}_{Z} sin α \\ \frac{- 2 {ρ}_{w} {h}_{f} η}{{μ}_{w}} {ω}_{Z} cos α & 1 & 0 \\ \frac{2 {ρ}_{w} {h}_{f} η}{{μ}_{w}} {ω}_{Z} sin α & 0 & 1\end{matrix} ] . \qquad ( 54 )$$

When solving the WF average velocity, one can cancel the second order small quantity η² produced in the dot-product of the Coriolis coefficient tensor with the gravity, centrifugal force vector. Then the WF velocity in (36) becomes

$${{V}^{->}}_{f} ( ξ , ϛ , η ) = {K}^{\overline{\_}} \cdot [ η \frac{{{τ}^{->}}_{m}}{{μ}_{m}} ] - {I}^{\overline{\_}} \cdot [ \frac{{ρ}_{w} {h}_{f} η}{{μ}_{w}} {{f}^{->}}_{gcf} ] , \qquad ( 55 )$$

where I̅ is the unit diagonal matrix; the shear stress vector \vec{τ}ₘ=τ_{mξ}i+τ_{mζ}j with τ_{mλ} and τ_{mζ} respectively being two components in the direction (ξ, ζ) of \vec{τ}ₘ. The term u_{ξ}, v_{ζ}, w_{η} is the three components in direction (ξ, ζ, η) of \vec{V}_{f}. Then,

$${{V}^{->}}_{f} ( ξ , ϛ , η ) = [ \begin{matrix}{u}_{ξ} \\ {v}_{ϛ} \\ {w}_{η}\end{matrix} ] = \frac{η}{{μ}_{m}} {A}^{->} - \frac{{ρ}_{w} {h}_{f} η}{{μ}_{w}} {B}^{->} + \frac{2 {ρ}_{w} {h}_{f} {ω}_{Z} {η}^{2}}{{μ}_{m}^{2}} {C}^{->} , \qquad ( 56 )$$

where the vector \vec{A}, \vec{B} and \vec{C} is respectively

$${A}^{->} = [ \begin{matrix}{τ}_{m ξ} \\ {τ}_{m ϛ} \\ 0\end{matrix} ] , {B}^{->} = {{f}^{->}}_{gcf} , {C}^{->} = [ \begin{matrix}{τ}_{m ϛ} cos α \\ - {τ}_{m ξ} cos α \\ {τ}_{m ξ} sin α\end{matrix} ] . \qquad ( 57 )$$

According to the definition (36), the average velocity of WF is

$${{V}^{{\_}^{->}}}_{f} ( ξ , ϛ , η ) = [ \begin{matrix}{\overline{u}}_{ξ} \\ {\overline{v}}_{ϛ} \\ {\overline{w}}_{η}\end{matrix} ] = \frac{{h}_{f}}{2 {μ}_{m}} {A}^{->} - \frac{{ρ}_{w} {h}_{f}^{2}}{2 {μ}_{w}} {B}^{->} + \frac{2 {ρ}_{w} {ω}_{z} {h}_{f}^{3}}{3 {μ}_{m}^{2}} {C}^{->} . \qquad ( 58 )$$

According to the equation (37), rewrite the continuity equation for the WF icing process

$$\frac{\partial {ρ}_{w} {h}_{f}}{\partial t} + \frac{\partial ( {ρ}_{w} {\overline{u}}_{ξ} {h}_{f} )}{\partial ξ} + \frac{\partial ( {ρ}_{w} {\overline{v}}_{ϛ} {h}_{f} )}{\partial ϛ} = {\dot{m}}_{1} - {\dot{m}}_{2} - {\dot{m}}_{3} , \qquad ( 59 )$$

where \dot{m}₁ is the function of a₂, \vec{V}₂ and T_{w}; \dot{m}₂ is the function of T_{w} and its expression is public known.

\dot{m}₁ is the added mass flux of the impacted SWD

\dot{m}₁=WC·α₂(\vec{V}₂•\vec{η}); (60)

\dot{m}₂ is the left mass flux of evaporation/vaporization of the WF

$${\dot{m}}_{2} = \frac{{h}_{c}}{R {C}_{pw} Le} ( \frac{{p}_{sw} ( {T}_{w} )}{{T}_{w}} - φ \frac{{p}_{s ∞}}{{T}_{∞}} ) , \qquad ( 61 )$$

where R is the gas constant; hₑ is the heat transfer coefficient; Le is the Lewis number and equal to 1; p_{sw} is the saturated vapor pressure and is function of T_{w}, which is given in an expression of fitting curve

p_{sw}(T_{w})=a₀+a₁(T_{w}−273)+a₂(T_{w}−273)²+a₃(T_{w}−273)³+a₄(T_{w}−273)⁴, (62)

with the constant a₀=611.01, a₁=44.4816, a₂=1.4188, a₃=0.0239, a₄=0.0002; the relative humidity φ is defined as

$$φ = \frac{{p}_{m}}{{p}_{sw}} . \qquad ( 63 )$$

According to the equation (38), rewrite the energy equation for icing process with assumption \dot{Q}ₕ=0. Then

$$\frac{\partial ( {ρ}_{w} {h}_{f} {C}_{pw} {T}_{w} )}{\partial t} + \frac{\partial ( {ρ}_{w} {u}_{ξ} {h}_{f} {C}_{pw} {T}_{w} )}{\partial ξ} + \frac{\partial ( {ρ}_{w} {v}_{ϛ} {h}_{f} {C}_{pw} {T}_{w} )}{\partial ϛ} = {\dot{Q}}_{1} - {\dot{Q}}_{2} + {\dot{Q}}_{3} , \qquad ( 64 )$$

where \dot{Q}₁ is the added heat flux of the SWD impinging, whose expression is given in (39);
\dot{Q}₂ is the left heat flux of evaporation/sublimation of the WF

\dot{Q}₂=0.5 (Lₑᵥₐₚ+L_{sab})\dot{m}₂; (65)
\dot{Q}₃ is the left heat flux of the WF icing

\dot{Q}₃=(L_{f}−ₚᵢT_{w})\dot{m}₃, (66)

where Lₑᵥₐₚ and L_{sub} the latent heat for evaporation and sublimation, L_{f} is the latent heat of fusion.

In this preferred embodiment, C_{pw} and, the specific heat at constant pressure of water and ice, the water density ρ_{w},the water kinetic viscosity μ_{w} are assumed constant, the continuity and energy equations for WF icing process (59) and (64), as the icing process model, can be written as in the conservation form

$$\frac{\partial {W}^{->}}{\partial t} + {\int }_{\partial Ω} {G}^{->} d S = {Q}^{->} , \qquad ( 67 )$$

where the conservation variable

$${W}^{->} = [ \begin{matrix}{h}_{f} \\ {h}_{f} {T}_{w}\end{matrix} ] ; \qquad ( 68 )$$

the convection vector \vec{G}=\vec{F}_{ξ}i+\vec{F}_{ζ}j has two components in direction (ξ,ζ):

$$\begin{matrix}{{F}^{->}}_{ξ} = [ \begin{matrix}{h}_{f}^{2} \frac{{τ}_{m ξ}}{2 {μ}_{m}} - {h}_{f}^{3} \frac{{ρ}_{w} {ω}_{Z}^{2} ( x cos θ + y sin θ )}{2 {μ}_{w}} + {h}_{f}^{4} \frac{2 {ρ}_{w} {ω}_{Z} {τ}_{m ϛ} cos α}{3 {μ}_{m}^{2}} \\ {T}_{w} {h}_{f}^{2} \frac{{τ}_{m ϛ}}{2 {μ}_{m}} - {T}_{w} {h}_{f}^{3} \frac{{ρ}_{w} {ω}_{Z}^{2} ( x cos θ + y sin θ )}{2 {μ}_{w}} - {T}_{w} {h}_{f}^{4} \frac{2 {ρ}_{w} {ω}_{Z} {τ}_{m ξ} cos α}{3 {μ}_{m}^{2}}\end{matrix} ] ; & ( 69 ) \\ {{F}^{->}}_{ϛ} = [ \begin{matrix}{h}_{f}^{2} \frac{{τ}_{m ξ}}{2 {μ}_{m}} - {h}_{f}^{3} \frac{{ρ}_{w} ( {g}_{z} sin α - {ω}_{Z}^{2} ( x cos α sin θ - y cos αcos θ ) )}{2 {μ}_{w}} + {h}_{f}^{4} \frac{2 {ρ}_{w} {ω}_{Z} {τ}_{m ϛ} cos α}{3 {μ}_{m}^{2}} \\ {T}_{w} {h}_{f}^{2} \frac{{τ}_{m ϛ}}{2 {μ}_{m}} - {T}_{w} {h}_{f}^{3} \frac{{ρ}_{w} ( {g}_{z} sin α - {ω}_{Z}^{2} ( x cos α sin θ - y cos α cos θ ) )}{2 {μ}_{w}} - {T}_{w} {h}_{f}^{4} \frac{2 {ρ}_{w} {ω}_{Z} {τ}_{m ξ} cos α}{3 {μ}_{m}^{2}}\end{matrix} ] ; & ( 70 )\end{matrix}$$

the source term

$${Q}^{->} = [ \begin{matrix}{\dot{m}}_{1} - {\dot{m}}_{2} - {\dot{m}}_{3} \\ \frac{1}{{ρ}_{w} {C}_{pw}} ( {\dot{Q}}_{1} - {\dot{Q}}_{2} + {\dot{Q}}_{3} )\end{matrix} ] . \qquad ( 71 )$$

The constrain condition for solving (67) is

h_{f}≧0; \dot{m}_{ice}≧0; h_{f}·T_{w}≧0; \dot{m}_{ice}·T_{w}≦0.

The solutions of (67) contain h_{f}, and \dot{m}₃. Make \dot{m}₃ divided by ρᵢ, one can obtain the ice thickness hᵢ

$${h}_{i} = \frac{{\dot{m}}_{3}}{{ρ}_{i}} . \qquad ( 73 )$$

A publicly known FVM based numerical method with cell center scheme, second-order Roe spatial and LUSGS implicit time discretization is used to solve the equations (67).

The FIG. 7 presents the numerically simulated flight-icing results within 7 minutes on a rotary-wing of helicopter. The results on three two-dimensional section planes illustrate the different icing states.

Plane 1, a section located two times distance in spanwise from the wing tip;

Plane 2, a section located one time distance in spanwise from the wing tip;

Plane 3, a section located half time distance in spanwise from the wing tip.

In the different planes, there are significant ice shape differences on the leading-edge of the wing. For example, on the plane 1, the ice is thicker on the upper side of the wing than that in other planes; while in the plane 2 the ice is thinner a little on the upper side and thicker on the lower side of the wing. All those phenomena reflect the effect of centrifugal and Coriolis force, which has a radical difference to the fixed wing flight-icing progress.

What is claimed is:

1. A numerical simulation method for the flight-icing of helicopter rotary-wings comprise an algorithm of adding the VCF (Vorticity Compensation Force) term to the momentum and energy equations describing the air-SWD (Supercooled water Droplets) two-phase rotational flows in the single fluid two-phase flow system in wake domain of helicopter-rotary wings; an algorithm of adding the centrifugal and Coriolis force to the slip velocity equation; models describing the WF (Water Film) movement and icing progress containing the effect of the centrifugal and Coriolis force; an procedure using the above algorithms and models to simulate the flight-icing of helicopter rotary-wings using computer codes running on computers.

2. The method of claim 1, wherein said added Vorticity Compensation Force is obtained by the density ρₘ of said air-SWD single fluid two-phase flow being multiplied by an unit vorticity diffusion compensation vector \vec{f}_{ω}, which has the expression as
\vec{f}_{ω}=\vec{n}_{ω}×(vₘ(∇²\vec{ω}ₘ)R_{c}),
where, \vec{n}_{ω} being the maximum gradient direction of vorticity magnitude;
v_{ω} being a contravariant numerical viscosity, as a scalar variable, with the same dimension as the fluid kinemics viscosity;
R_{c} being a characteristic radii of the vorticity compensation;
\vec{ω}ₘ, being a vorticity of said air-SWD single fluid two-phase flow;
symbol×being the cross-product operation;
symbol ∇² being the Laplacian operator.

3. The method of claim 2, wherein said contravariant numerical viscosity v_{ω} is defined as
v_{ω}≡\vec{v}ₘ•\vec{n},
where \vec{v}_{ω} being a numerical viscosity vector; \vec{n}=└nₓ, n_{y}, n_{z} ┘ being an unit normal direction vector of computing grid interfaces; symbol•being the dot-product.

4. The method of claim 3, wherein said numerical viscosity vector \vec{v}_{ω} is defined as
$${{v}^{->}}_{ω} = \frac{{{R}^{->}}_{ω}^{2}}{\vert {ω}^{->} \vert} ,$$
where \vec{R}_{ω} being a radii vector of the compensated voracity.

5. The method of claim 1, wherein said act of adding the centrifugal and Coriolis force to the slip velocity equation includes that said centrifugal and Coriolis force are in form of body force vector.

6. The method of claim 1, wherein said models describing the WF movement and icing progress containing the effect of the centrifugal and Coriolis force can derive \vec{V}_{f}, the velocity vector on the plane (, c) at height η in said WF based on the local coordinator system (η,ξ,ζ), the \vec{V}_{f} is written as
$${{V}^{->}}_{f} ( ξ , ϛ , η ) = {K}^{\overline{\_}} \cdot η [ \frac{{{τ}^{->}}_{m}}{{μ}_{m}} - \frac{{ρ}_{w} ( {h}_{f} - η )}{{μ}_{w}} {{f}^{->}}_{gcf} ] ,$$
where μ_{w} and ρ_{w} is the kinematic viscosity and density of said WF; at the interface between said WF and said air-SWD two-phase flows, \vec{τ}ₘ is the shear stress vector in direction (ξ,ζ) and μₘ is the kinematic viscosity of said mixture; h_{f} is the height of said WF; \vec{f}_{gcf} is the projected summation of the unit gravity \vec{g} and centrifugal \vec{f}_{centr} on the local coordinator system K̅ is the Coriolis coefficient tensor.

7. The method of claim 6, wherein said Coriolis coefficient tensor K̅ is expressed as
$${K}^{\overline{\_}} = [ \begin{matrix}1 & - {k}_{3} & {k}_{2} \\ {k}_{3} & 1 & - {k}_{1} \\ - {k}_{2} & {k}_{1} & 1\end{matrix} ] ,$$
where the element [k₁, k₂, k₃ ] are the three components of the vector \vec{k} in the direction (ξ,ζ,η); and \vec{k} is expressed as
$${k}^{->} = {[ {k}_{1} , {k}_{2} , {k}_{3} ]}^{T} = \frac{- 2 {ρ}_{w} η ( {h}_{f} - η )}{{μ}_{w}} {{ω}^{->}}_{OZ , f} ,$$
where \vec{ω}_{OZ,f} is the projection of helicopter rotary-wing rotating speed of \vec{ω}_{OZ} on said local coordinator system (η,ξ,ζ).

8. The method of claim 1, wherein said procedure to simulate the flight-icing of helicopter rotary-wings includes the following steps
(1) build the rotating frame of reference and generate the computing grid around the un-iced rotary-wings;
(2) divide the whole computational domain into three sub-domains: the far-filed, near-filed and wake domain;
(3) specify the initial time t;
(4) solve the governing equations for the air and SWD flows at the far-field domain to obtain the velocity, density, pressure, temperature, turbulence of air flow and the velocity of SDW;
(5) solve the governing equations for the air-SWD single fluid two-phase mixture flows at the near-field and wake domain to obtain the pressure pₘ, velocity \vec{V}ₘ, temperature Tₘ, dynamic viscosity μₘ, and shear stress τₘ;
(6) solve the WF movement equation to obtain \vec{V}_{f}, the velocity of the WF and find the WF thickness h _{f};
(7) solve the icing progress model to find the ice thickness and obtain the iced configuration of rotary-wings;
(8) regenerate the computing grid;
(9) go back to step (2) for the computation at the next time (t+Δt).
